(19) United States
(12) Patent Application Publication
(10) Pub. No.: US 2023/0382179 A1
(43) Pub. Date: Nov. 30, 2023

(54) APPARATUS OF DECREASING INTAKE AIR TEMPERATURE OF ENGINE

(71) Applicants: Hyundai Motor Company, Seoul (KR); Kia Corporation, Seoul (KR)

(72) Inventors: Jaeheun KIM, Pyeongtaek-Si (KR); Dong Hee HAN, Seongnam-Si (KR); Jong II PARK, Seoul (KR); Seungwoo HONG, Seoul (KR); Jonghyeok LEE, Hwaseong-Si (KR); Kwanhee LEE, Suwon-Si (KR); JaUn KU, Suwon-Si (KR); Hyunjin KANG, Hwaseong-Si (KR)

(73) Assignees: Hyundai Motor Company, Seoul (KR); Kia Corporation, Seoul (KR)

(21) Appl. No.: 17/992,248

(22) Filed: Nov. 22, 2022

(30) Foreign Application Priority Data
May 24, 2022 (KR) 10-2022-0063652

(51) Int. Cl. B60H 1/00; F01P 3/22; F01P 3/18; F01P 5/12

(52) U.S. Cl. CPC B60H 1/00271; F01P 3/22; F01P 3/18; F01P 5/12; B60H 1/00878; B60H 1/00764; B60H 1/0073; F01P 2003/2214; F01P 2025/13; F01P 2025/64; B60H 1/00485; B60H 1/00428

(57) ABSTRACT

An apparatus of decreasing intake air temperature of an engine includes: a first cooling circuit including a compressor, a condenser, a first expansion valve, and an evaporator disposed along a first cooling line through which refrigerant flows; a second cooling circuit including the compressor, the condenser, a second expansion valve, and a chiller disposed along a second cooling line through which the refrigerant flows; and a third cooling circuit including an electric water pump, the chiller, an intercooler, and a radiator disposed along a third cooling line through which coolant flows.

### CROSS-REFERENCE TO RELATED APPLICATION

The present application claims priority to Korean Patent Application No. 10-2022-0063652 filed on May 24, 2022, the entire contents of which is incorporated herein for all purposes by this reference.

### BACKGROUND OF THE PRESENT DISCLOSURE

### Field of the Present Disclosure

The present disclosure relates to an apparatus of decreasing intake air temperature of an engine. More particularly, the present disclosure relates to an apparatus of decreasing intake air temperature of an engine for reducing intake air temperature through a cooling circuit used for cabin air conditioning of a vehicle.

### Description of Related Art

Generally, fuel injection quantity in a gasoline engine is determined based on a stoichiometric air-fuel ratio. As fuel amount approaches to the stoichiometric air-fuel ratio, the fuel may be completely combusted in the cylinder and the conversion efficiency of an exhaust gas catalyst is improved when running at stoichiometric air-fuel ratio.

However, to protect the engine from a high exhaust gas temperature generated in high load condition, a method of reducing the exhaust gas temperature through rich combustion (or fuel enrichment) was conventionally used.

However, in recent years, to reduce air pollution caused by the exhaust gas, the fuel enrichment is being regulated worldwide. Therefore, technologies such as a Miller cycle is being developed to operate the entire operation area under stoichiometric air-fuel ratio.

However, when the engine operates under high-speed and high-load conditions when the intake air temperature of the engine is not sufficiently cooled (e.g., over 35 degrees Celsius) due to high ambient air temperature, it causes the exhaust gas temperature to rise again.

Because the fuel enrichment is forbidden due to the regulations in the future, the only methods for reducing the exhaust gas temperature are by limiting the maximum output of the engine, or by additionally cooling the intake air temperature to reduce the exhaust gas temperature without limiting the engine output. Therefore, research for reducing the temperature of the intake air while minimizing the engine performance deterioration is required.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing an apparatus that can reduce the temperature of the intake air temperature of an engine without using fuel enrichment (rich combustion) when the ambient air temperature is high.

An apparatus of decreasing intake air temperature of an engine according to various exemplary embodiments of the present disclosure includes: a first cooling circuit including a compressor, a condenser, a first expansion valve, and an evaporator disposed along a first cooling line through which refrigerant flows; a second cooling circuit including the compressor, the condenser, a second expansion valve, and a chiller disposed along a second cooling line through which the refrigerant flows; and a third cooling circuit including an electric water pump, the chiller, an intercooler, and a radiator disposed along a third cooling line through which coolant flows.

The apparatus of decreasing the intake air temperature of the engine may further include a controller electrically connected to the compressor, the first expansion valve, and the second expansion valve and configured for generating a first Pulse-width modulation (PWM) signal if cabin temperature control demand is requested by a driver, or generating a second PWM signal if intake air temperature control condition is satisfied, and thus controlling the compressor, the first expansion valve, and the second expansion valve according to the first PWM signal and the second PWM signal.

The intake air temperature control condition may be determined based on ambient air temperature, intake air temperature, exhaust temperature, or engine speed.

The intake air temperature control condition may be satisfied if the engine speed is greater than or equal to a predetermined speed, and the ambient air temperature is greater than or equal to a predetermined temperature, or the intake air temperature is greater than or equal to a predetermined temperature, or the exhaust temperature is greater than or equal to a predetermined temperature.

The cabin temperature control request may be determined by a blower adjustor input command by the driver, and a temperature adjuster input command by the driver.

When the first PWM signal and the second PWM signal are generated simultaneously, the controller may operate the compressor through a summed PWM signal values of the first PWM signal and the second PWM signal, and opening and closing timing of the first expansion valve and the second expansion valve may be controlled according to a ratio of the first PWM signal and the second PWM signal from the summed PWM signals.

When only the first PWM signal is generated, the controller may operate the compressor through the first PWM signal, open the first expansion valve, and shut off the second expansion valve.

When only the second PWM signal is generated, the controller may operate the compressor through the second PWM signal, shut off the first expansion valve, and open the second expansion valve.

According to the apparatus of decreasing the intake air temperature of the engine according to various exemplary embodiments of the present disclosure as described above, the intake air temperature may be precisely controlled when the ambient air temperature is high, by additionally cooling the coolant cooled by both the radiator and the chiller.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a schematic view showing a configuration of an apparatus of decreasing intake air temperature of an engine according to various exemplary embodiments of the present disclosure.

FIG. 2 is a block diagram showing a configuration of an apparatus of decreasing intake air temperature of an engine according to various exemplary embodiments of the present disclosure.

FIG. 3 is a flowchart showing a method of controlling an apparatus of decreasing intake air temperature of an engine according to various exemplary embodiments of the present disclosure.

FIG. 4 is a graph for explaining an operation of an apparatus of decreasing intake air temperature of an engine according to various exemplary embodiments of the present disclosure.

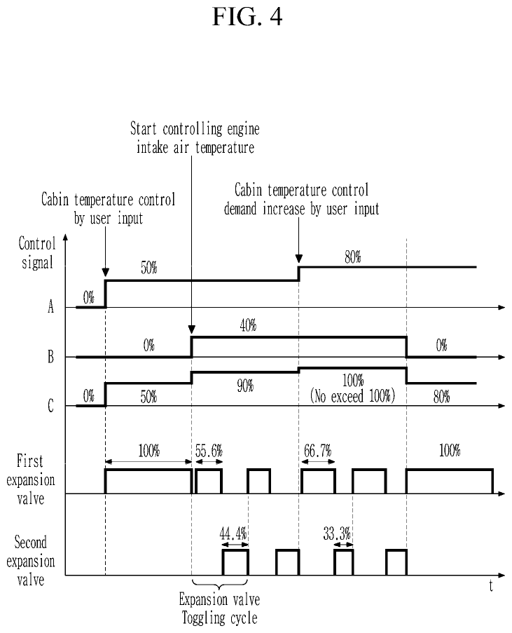

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

The present disclosure will be described in more detailed manner hereinafter with reference to the accompanying drawings, in which embodiments of the present disclosure are shown. As those skilled in the art would realize, the described embodiments may be modified in various different ways, all without departing from the spirit or scope of the present disclosure.

The drawings and description are to be regarded as illustrative in nature and not restrictive, and like reference numerals designate like elements throughout the specification.

Because size and thickness of each component illustrated in the drawings are arbitrarily represented for convenience in explanation, the present disclosure is not particularly limited to the illustrated size and thickness of each component and the thickness is enlarged and illustrated to clearly express various portions and areas.

Hereinafter, an apparatus of decreasing intake air temperature of an engine according to various exemplary embodiments of the present disclosure is described in detail with reference to the accompanying drawings.

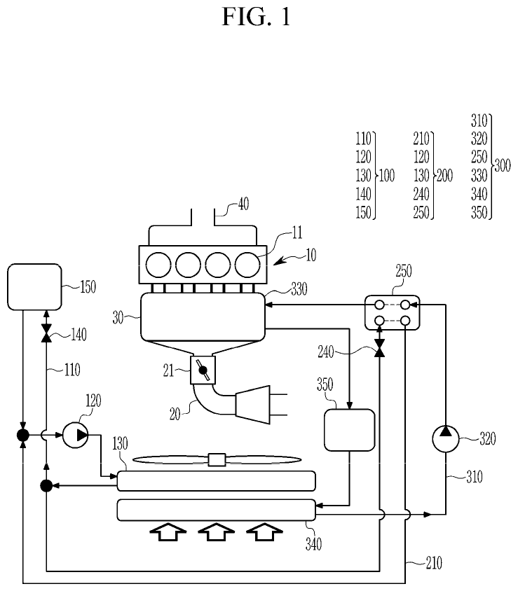

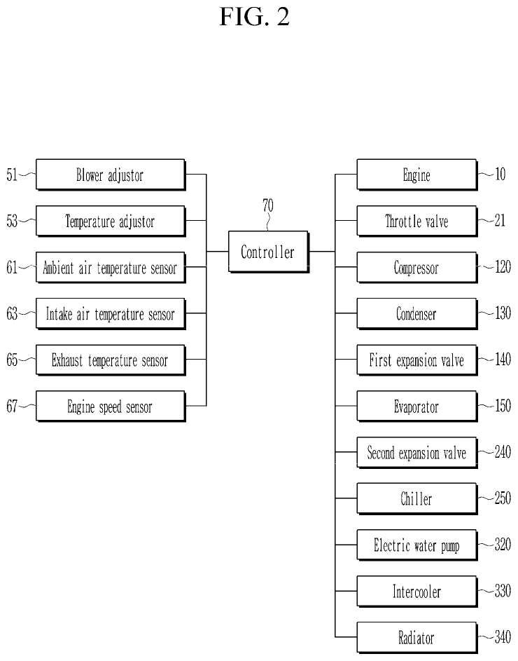

FIG. 1 is a schematic view showing a configuration of an apparatus of decreasing intake air temperature of an engine according to various exemplary embodiments of the present disclosure. FIG. 2 is a block diagram showing a configuration of an apparatus of decreasing intake air temperature of an engine according to various exemplary embodiments of the present disclosure.

First, an engine system to which an apparatus of decreasing intake air temperature of an engine according to various exemplary embodiments of the present disclosure is applied is described with reference to FIG. 1 and FIG. 2.

The engine system includes an engine 10 including a plurality of combustion cylinders 11 generating power by combustion of fuel, an intake air line 20 through which intake air flow into the engine 10, and an exhaust manifold 40 for exhausting exhaust gas generated from the engine 10.

The intake air line 20 is provided with a throttle valve 21, and the amount of the intake air supplied to the engine 10 is controlled by the opening of the throttle valve 21.

The intake air manifold 30 is provided between the throttle valve 21 and the engine and the intake air supplied through the intake air line 20 is distributed to a plurality of combustion cylinders 11 by the intake air manifold 30. In various exemplary embodiments of the present disclosure, the intake air manifold 30 includes an integrated intercooler 330. That is, the intake air manifold 30 includes a water-cooled type integrated intercooler 330. After, the intake air that flow through intake air line 20 is cooled by heat-exchange process with the coolant inside the intercooler 330 and then flows into the engine 10.

The apparatus of decreasing the intake air temperature of the engine according to various exemplary embodiments of the present disclosure includes a first cooling circuit 100 in which the refrigerant circulates, a second cooling circuit 200 in which the refrigerant circulates, and a third cooling circuit 300 in which the coolant circulates.

The first cooling circuit 100 is a cooling circuit for air conditioning of the internal cabin of the vehicle, in which a compressor 120, a condenser 130, a first expansion valve 140, and an evaporator 150 are sequentially disposed along the first cooling line 110 through which the refrigerant flows.

The refrigerant in the gaseous state flowing along the first cooling line 110 is compressed by the compressor 120 and becomes a high-temperature, high-pressure gas. The high-temperature, high-pressure refrigerant compressed by the compressor 120 passes through the condenser 130 and is converted into a liquid phase and the heat is released. The refrigerant in liquid phase passes through the first expansion valve 140, and the flow rate increases due to the expansion and the pressure drop. The liquid phase refrigerant of low temperature and low pressure passing through the first expansion valve 140 absorbs heat from the surrounding ambient air while passing through the evaporator 150 and evaporates into a gas state.

The second cooling circuit 200 is a cooling circuit for cooling the intake air flowing into the engine 10, in which a compressor 120, a condenser 130, a second expansion valve 240, and a chiller 250 are sequentially disposed along the second cooling line 210 through which the refrigerant flows.

The refrigerant in gaseous state flowing along the second cooling line 210 is compressed by the compressor 120 and becomes a high temperature and high pressure gas. The refrigerant of a high temperature and high pressure compressed by the compressor 120 passes through the condenser 130 and is converted into a liquid phase and heat is released. The flow rate increases while the liquid phase refrigerant passes through the second expansion valve 240 with a pressure drop. The liquid phase refrigerant of a low temperature and low pressure passing through the second expansion valve 240 absorbs heat from the coolant in the third cooling circuit 300 while passing through the chiller 250 and evaporates into a gas state.

In the first cooling circuit 100 and the second cooling circuit 200, the first cooling line 110 and the second cooling line 210 are partially shared, and some components are also partially shared.

In various exemplary embodiments of the present disclosure, the compressor 120 and the condenser 130 are shared with each other in the first cooling circuit 100 and the second cooling circuit 200.

Also, the first cooling line 110 between the compressor 120 and the condenser 130 of the first cooling circuit 100 is shared with the second cooling line 210 between the compressor 120 and the condenser 130 of the second cooling circuit 200.

The third cooling circuit 300 is a cooling circuit for cooling the coolant of the water-cooled intercooler 330 that cools the temperature of the intake air inflowing to the engine 10, in which an electric water pump 320, a chiller 250, an intercooler 330, a water tank 350, and a radiator 340 are sequentially disposed along the third cooling line 310 through which the coolant flows.

The coolant of the third cooling circuit 300 is pumped by the electric water pump (320, EWP) and the coolant flows along the third cooling line 310.

The coolant heated by the heat-exchange process with the intake air in the intercooler 330 is cooled by the heat-exchange with the ambient air through the radiator 340, and further cooled through the heat-exchange with the refrigerant through the chiller 250. That is, in various exemplary embodiments of the present disclosure, by cooling the coolant for cooling the intake air through both the radiator 340 and the chiller 250, it is possible to further lower the temperature of the intake air flowing into the engine 10 even when the ambient temperature is high.

The apparatus of decreasing the intake air temperature of the engine according to various exemplary embodiments of the present disclosure may include a controller 70 for controlling the first, second, and third cooling circuits 300 based on the vehicle's cabin temperature control demand request and the intake air temperature control condition.

The controller 70 may be provided with at least one processor operated by a predetermined program, and the predetermined program performs each step of the method of controlling the apparatus of decreasing the intake air temperature of the engine according to various exemplary embodiments of the present disclosure.

The cabin temperature control demand is determined through the blower adjustor 51 and the temperature adjustor 53 provided inside the vehicle cabin. That is, the cabin temperature control demand may include a number of blower stages input through the blower adjustor 51, and a predetermined temperature input through the temperature adjustor 53.

The blower adjustor 51 is an input device that adjusts the strength of the wind which is blown into the vehicle's cabin through the air conditioner, and is operated by the user. When the user adjusts the number of stages (e.g., 0-7 stages) of the blower adjustor 51, the strength of the wind flowing into the vehicle cabin through the air conditioner is adjusted. The number of blower stages of the blower adjustor 51 input by the user is transmitted to the controller 70.

The temperature adjustor 53 is an input device that is configured to control the temperature of the wind flowing into the vehicle's cabin through the air conditioner, and is operated by the user. When the user adjusts the temperature adjustor 53, the temperature of the wind flowing into the vehicle through the air conditioner is adjusted. The predetermined temperature of the temperature adjustor 53 input by the user is transmitted to the controller 70. When the blower stage number and target temperature are input through the blower controller 51 and the temperature controller 53, and the controller 70 generates a first Pulse-width modulation (PWM) signal of the first cooling circuit 300 through a pre-defined map table.

To determine the intake air temperature control condition, the apparatus of decreasing the intake air temperature of the engine according to various exemplary embodiments of the present disclosure may include an ambient air temperature sensor 61, an intake air temperature sensor 63, an exhaust temperature sensor 65, and an engine speed sensor 67.

The ambient air temperature sensor 61 detects the ambient air temperature, and the temperature value is transmitted to the controller 70. The intake air temperature sensor 63 detects the intake air temperature flowing into the engine 10, and the detected intake air temperature is transmitted to the controller 70. The exhaust temperature sensor 65 detects the exhaust temperature exhausted from the engine 10, and the detected exhaust temperature is transmitted to the controller 70. Alternatively, an estimated exhaust temperature value may be determined by the controller from a model pre-provided inside the controller according to the driving conditions and driving time of the engine, and the determined exhaust temperature may be transmitted to the controller. Also, the engine speed sensor 67 detects the rotation speed (rpm) of the engine 10, and the detected speed of the engine 10 is transmitted to the controller 70.

The controller 70 determines whether the intake air temperature control condition is satisfied based on the ambient air temperature, the intake air temperature, the exhaust temperature, and the rotation speed of the engine 10. In various exemplary embodiments of the present disclosure, the intake air temperature control condition may be satisfied when the engine speed is greater than or equal to a predetermined speed (e.g., 4000 rpm), and the ambient air temperature is greater than or equal to a predetermined temperature (e.g., 30 degrees Celsius), or the intake air temperature is greater than or equal to a predetermined temperature (e.g., 35 degrees Celsius), or the exhaust temperature is higher than or equal to a predetermined temperature (e.g., 945 degrees Celsius). When the intake air temperature control condition is satisfied, the controller 70 generates a second PWM signal.

In other words, if the engine speed is greater than or equal to a predetermined speed and the ambient air temperature is greater than or equal to a predetermined temperature, if the engine speed is greater than or equal to a predetermined speed and the intake air temperature is greater than or equal to a predetermined temperature, or if the engine speed is greater than or equal to a predetermined speed and the exhaust temperature is greater than or equal to a predetermined temperature, the intake air temperature control condition may be satisfied.

The controller 70 is configured to control each constituent element of the first, second, and third cooling circuits 300 according to the first PWM signal and the second PWM signal.

Hereinafter, the operation of the apparatus of decreasing the intake air temperature of the engine according to various exemplary embodiments of the present disclosure as described above is described in detail with reference to the accompanying drawings.

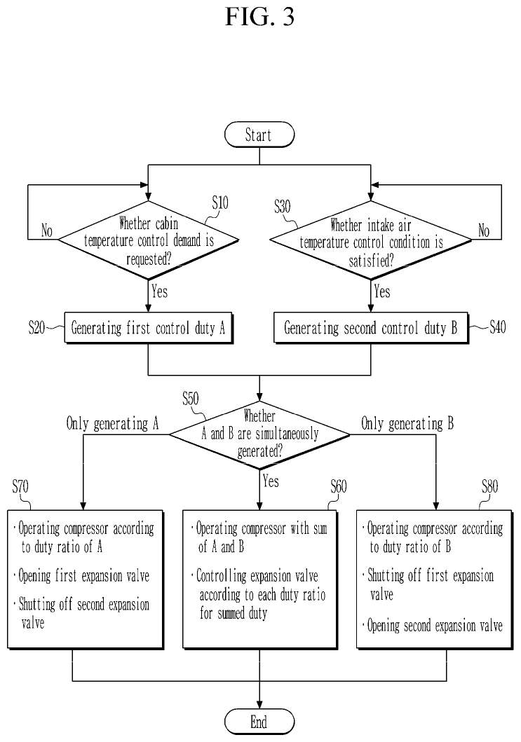

FIG. 3 is a flowchart showing a method of controlling an apparatus of decreasing intake air temperature of an engine according to various exemplary embodiments of the present disclosure.

Referring to FIG. 3, the controller 70 determines whether the cabin temperature control demand is requested by the driver (S10). When the cabin temperature control demand is requested, the controller 70 generates a first PWM signal A based on a pre-defined map table. The first PWM signal is defined between 0 to 100%.

Also, the controller 70 determines whether the intake air temperature control condition is satisfied (S20). The intake air temperature control condition, as described above, is determined based on the ambient air temperature, the intake air temperature, the exhaust temperature, and the rotation speed of the engine 10. When the intake air temperature control condition is satisfied, the controller 70 generates a second PWM signal B based on the pre-defined map table. The second PWM signal is defined between 0 to 100%.

The controller 70 determines whether the first PWM signal and the second PWM signal are simultaneously generated.

When the first PWM signal and the second PWM signal are simultaneously generated, the controller 70 sums the first PWM signal and the second PWM signal, and operates the compressor 120 according to the summed PWM signal (a summed PWM signal, C) (S60). Here, the summed PWM signal is defined between 0 to 100%. That is, the maximum value of the summed PWM signal is 100%.

That is, when the first PWM signal is A % and the second PWM signal is B %, the summed PWM signal is A %+B %. Accordingly, the controller 70 operates the compressor 120 with PWM signal of A %+B % which is the summed PWM values. In other words, the sum of the first PWM signal and the second PWM signal becomes the final summed PWM signal operating the compressor 120.

Also, the controller 70 is configured to control the opening and closing timing of the first expansion valve 140 and the second expansion valve 240 according to the ratio of each PWM signal (the first and second PWM signals) out of the total summed PWM signals of the first PWM signal and the second PWM signal.

That is, the controller 70 is configured to control the opening and closing timing of the first expansion valve 140 according to the ratio (a first PWM duty ratio) of the first PWM signal out of the summed PWM signal, and is configured to control the opening and closing timing of the second expansion valve 240 according to the ratio (a second PWM duty ratio) of the second PWM signal out of the summed PWM signal. Here, the duty ratio means a ratio of each PWM signal (the first and second PWM signals) to the summed PWM signal.

That is, if the first PWM signal is A % and the second PWM signal is B %, the summed PWM signal of the first PWM signal and the second PWM signal is A %+B %. At the instant time, the first expansion valve 140 is opened during the first PWM signal A % out of the summed PWM signal A %+B %. In other words, the first expansion valve 140 may be opened with the duty ratio (the first PWM duty ratio) of [A %/(A %+B %)].

And the second expansion valve 240 is opened during the second PWM signal (B %) out of the summed PWM signal (A %+B %). In other words, the second expansion valve 240 may be opened with a duty ratio (a second PWM duty ratio) of [B %/(A %+B %)].

For example, if the first PWM signal is 50% and the second PWM signal is 40%, the controller 70 operates the compressor 120 at the ratio of 90% (the summed PWM duty ratio) which is the sum of the first PWM signal and the second PWM signal.

Also, the first expansion valve 140 is opened at the ratio (the first PWM duty ratio) of the first PWM signal 50% to the summed PWM signal 90% of the first PWM signal 50% and the second PWM signal 40%. Here, the first expansion valve 140 is opened with the duty ratio of 50%/90% (approximately 55.6%).

Likewise, the second expansion valve 240 is opened at the ratio (the second PWM duty ratio) of the second PWM signal 40% to the summed PWM signal 90%. Here, the second expansion valve 240 is opened with the duty ratio of 40%/90% (approximately 44.4%).

When only the first PWM signal is generated, the controller 70 operates the compressor 120 according to the first PWM signal (S70). Then, the controller 70 opens the first expansion valve 140 and shuts off the second expansion valve 240.

For example, if the first PWM signal is 50% and the second PWM signal is 0%, the size of the first PWM signal 50% becomes the summed PWM duty ratio for operating the compressor 120, and accordingly, the controller 70 operates the compressor 120 with the duty ratio of 50% (the summed PWM duty ratio). Also, the first expansion valve 140 is opened, and the second expansion valve 240 is shut off.

When only the second PWM signal is generated, the controller 70 operates the compressor 120 according to the second PWM signal (S80). Then, the controller 70 opens the second expansion valve 240 and shuts off the first expansion valve 140.

For example, if the first PWM signal is 0% and the second PWM signal is 40%, the second PWM signal 40% becomes the summed PWM signal for operating the compressor 120, and accordingly, the controller 70 operates the compressor 120 with PWM signal of 40%. Then, the second expansion valve 240 is opened, and the first expansion valve 140 is shut off.

According to the apparatus of decreasing the intake air temperature of the engine according to various exemplary embodiments of the present disclosure as described above, by adding the chiller 250 to the third cooling circuit 300 that cools the coolant, the coolant cooled by the radiator 340 may be additionally cooled, and thereby the control robustness of the intake air temperature may be secured.

Also, by controlling the intake air temperature through the coolant of which the temperature is lowered, even under sever conditions such as high ambient air temperature, there is no need to perform the exhaust temperature control by a separate control method, for example fuel enrichment (rich combustion), so that the entire operation area of the engine 10 may be controlled with stoichiometric air-fuel ratio.

Furthermore, because the second cooling circuit 200 is disposed in parallel with the first cooling circuit 100 that is configured to control the cabin air temperature of the vehicle, the compressor 120 is shared with the first cooling circuit 100 and the second cooling circuit 200, it is possible to easily control the intake air temperature while reducing the manufacturing cost of the vehicle.

Furthermore, the term related to a control device such as “controller”, “control apparatus”, “control unit”, “control device”, “control module”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may process data according to a program provided from the memory, and may generate a control signal according to the processing result.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like.

In various exemplary embodiments of the present disclosure, each operation described above may be performed by a control device, and the control device may be configured by a plurality of control devices, or an integrated single control device.

In various exemplary embodiments of the present disclosure, the scope of the present disclosure includes software or machine-executable commands (e.g., an operating system, an application, firmware, a program, etc.) for facilitating operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. An apparatus of decreasing intake air temperature of an engine, the apparatus comprising:
a first cooling circuit including a compressor, a condenser, a first expansion valve, and an evaporator disposed along a first cooling line through which refrigerant flows;
a second cooling circuit including the compressor, the condenser, a second expansion valve, and a chiller disposed along a second cooling line through which the refrigerant flows; and
a third cooling circuit including an electric water pump, the chiller, an intercooler, and a radiator disposed along a third cooling line through which coolant flows.

2. The apparatus of claim 1, further including
a controller electrically connected to the compressor, the first expansion valve, and the second expansion valve and configured for generating a first Pulse-width modulation (PWM) signal when vehicle cabin temperature control demand is requested, generating a second PWM signal when intake air temperature control condition is satisfied, and controlling the compressor, the first expansion valve, and the second expansion valve according to the first PWM signal and the second PWM signal.

3. The apparatus of claim 2, wherein the intake air temperature control condition is determined based on ambient air temperature, intake air temperature, exhaust temperature, or engine speed.

4. The apparatus of claim 3, wherein the intake air temperature control condition is satisfied when the engine speed is greater than or equal to a predetermined speed, and the ambient air temperature is greater than or equal to a predetermined temperature, or the intake air temperature is greater than or equal to a predetermined temperature, or the exhaust temperature is greater than or equal to a predetermined temperature.

5. The apparatus of claim 2, wherein the cabin temperature control demand is determined by a blower adjustor electrically connected to the controller and receiving an input signal from the driver, and a temperature adjuster electrically connected to the controller and receiving an input signal from the driver.

6. The apparatus of claim 2, wherein
when the first PWM signal and the second PWM signal are simultaneously generated,
the controller is configured to operate the compressor through a summed PWM signal of which the first PWM signal and the second PWM signal are summed, and
the controller is configured to control opening and closing timing of the first expansion valve and the second expansion valve according to a ratio of the first PWM signal and the second PWM signal out of the summed PWM signal.

7. The apparatus of claim 2, wherein when only the first PWM signal is generated, the controller is configured to operate the compressor through the first PWM signal, to open the first expansion valve, and to shut off the second expansion valve.

8. The apparatus of claim 2, wherein when only the second PWM signal is generated, the controller is configured to operate the compressor through the second PWM signal, to shut off the first expansion valve, and to open the second expansion valve.

9. A method of controlling the apparatus of claim 1, the method comprising:
determining, by a controller, whether a cabin temperature control demand is requested, and when the cabin temperature control demand is requested, generating a first PWM signal based on a pre-defined map table;
determining, by the controller, whether an intake air temperature control condition is satisfied, and when the intake air temperature control condition is satisfied, generating a second PWM signal based on the pre-defined map table; and
controlling, by the controller, the compressor, the first expansion valve, and the second expansion valve according to the first PWM signal and the second PWM signal.

10. The method of claim 9, further including:
wherein when the first PWM signal and the second PWM signal are simultaneously generated,
operating, by the controller, the compressor through a summed PWM signal of which the first PWM signal and the second PWM signal are summed, and
controlling, by the controller, opening and closing timing of the first expansion valve and the second expansion valve according to a ratio of the first PWM signal and the second PWM signal out of the summed PWM signal.

11. The method of claim 9, wherein when only the first PWM signal is generated, the controller is configured to operate the compressor through the first PWM signal, to open the first expansion valve, and to shut off the second expansion valve.

12. The method of claim 9, wherein when only the second PWM signal is generated, the controller is configured to operate the compressor through the second PWM signal, to shut off the first expansion valve, and to open the second expansion valve.

13. The method of claim 9, wherein the intake air temperature control condition is determined based on ambient air temperature, intake air temperature, exhaust temperature, or engine speed.

14. The method of claim 13, wherein the intake air temperature control condition is satisfied when the engine speed is greater than or equal to a predetermined speed, and the ambient air temperature is greater than or equal to a predetermined temperature, or the intake air temperature is greater than or equal to a predetermined temperature, or the exhaust temperature is greater than or equal to a predetermined temperature.

15. The method of claim 9, wherein the cabin temperature control demand is determined by a blower adjustor electrically connected to the controller and receiving an input signal from a driver, and a temperature adjuster electrically connected to the controller and receiving an input signal from the driver.

16. A non-transitory computer readable storage medium on which a program for performing the method of claim 9 is recorded.
